(19) United States
(12) Patent Application Publication
(10) Pub. No.: US 2002/0046208 A1
(43) Pub. Date: Apr. 18, 2002

(54) Objects in a computer system

(76) Inventors: Johan Andersson, Vasteras (SE); Mikael Rudin, Vasteras (SE); Thomas Pauly, Vasteras (SE)

Correspondence Address: Dykema Gossett PLLC, Third Floor West, Franklin Square, 1300 I Street, N.W., Washington, DC, 20005-3306, US

(21) Appl. No.: 09/973,195

(22) Filed: Oct. 10, 2001

(30) Foreign Application Priority Data
Oct. 12, 2000 (GB) 0025051.4

(51) Int. Cl. G06F 7/00

(52) U.S. Cl. 707/3; 707/1

(57) ABSTRACT

A method in an object oriented computer system is disclosed. In an object oriented computer system objects are enabled to have relationships with each other. In the method a query is received for a path of related objects, the query including information regarding an object and relationships associated with the object. The different relationships associated with objects in the system are analysed to select objects based on said information included in the query. Based on said analysis, a path of related objects is selected, one of the objects in the path being the object indicated by the query.

### FIELD OF THE INVENTION

The present invention relates to objects in a computerised system, and in particular, but not exclusively, how to locate objects in a computerised system.

### BACKGROUND OF THE INVENTION

In contemporary computer based systems for controlling e.g. manufacturing and process industries, such as chemical plants, oil refineries, pulp and paper mills, steel mills, automated factories and so on, or other control systems, such as traffic management systems, there has typically existed a large range of different applications of different origin that have had to be integrated into a single control system. Further, a control system may include several computers connected through a communication network, where said applications are distributed in different configurations for different installations. A data communication network may be a closed local network (e.g. a local area network LAN), a closed global network (e.g. an intranet network) or an open global network (e.g. the Internet).

Object-oriented programming languages and methods have been introduced to enable shorter development times of the computerised applications and to ease incorporation or integration of new applications. An aim of the object oriented techniques is to break the task down to smaller autonomous entities that are enabled to work together to provide the needed functionality. These individual entities are called objects. During the development of the of the set of control instructions (i.e. the control software) the designer determines what objects are needed and the interrelations of each chosen object with other objects. When the control program is run, a functionality of the program may call an object that is stored e.g. in a database of the control system. An example of an object that may be need to be called during controlling operations of a processing plant is a certain pump in a certain part of the process. Examples of object oriented technology, without limiting to these, include technologies such as C++ or Java.

An object may have different aspects, each aspect defining more precisely a characteristic and/or function of the object. That is, an object may associate with one or more different aspects that represent facets of the real world entity that the object represents. An aspect may provide a piece of the functionality of the object. An instance of an object typically refers to an object that has been instantiated to associate with necessary aspects. An aspect may be either exclusive or shared by several objects. An object may inherit an aspect from another object.

If an object is to be called for use by a program, it needs to be located. That is, there has to be a way of finding the object so that the object can be called. The objects are typically called and located by their names, hence the term name-look up. To make the name look-up easier the object names have been conventionally arranged in a hierarchical order by so called directory or folder trees. The tree is arranged such that is has a main folder (root) and possible subfolders that are dependent from the main folder. The subfolder can be found by indicating the name of the main folder and any possible other subfolders in the tree between the main folder and the requested subfolder.

In a conventional tree type arrangement an object can be placed only in one directory or folder. In order to find the object, such as a certain pump in a plant, the search function has to go through the entire list or table of pumps in a given folder for the given plant. In addition, the search function needs to know the exact name or other identity of object, such as the ID number of the pump, to be able to locate it. If the object is placed in a subfolder of a folder (which folder in turn may be a subfolder of a folder above it), the search function has to know, in addition to the exact name for the object, the exact look-up names for all these folder items in the path between the main (root) folder and the folder containing the requested object.

### SUMMARY OF THE INVENTION

Embodiments of the present invention aim to address one or several of the above problems.

According to one aspect of the present invention a method is provided for an object oriented computer system, wherein objects are enabled to have relationships with each other. In the method a query for a path of related objects is received, the query including information regarding an object and relationships associated with the object. The different relationships associated with objects in the system are then analysed to select objects based on said information included in the query. A path of related objects is selected based on said analysis. One of the objects in the path is the object indicated by the query.

The path of related objects may extend between said one object and a root of a structure, said structure being arranged to organise objects relative to each other. The analysing may comprise determination of the number of relationships each analysed object has with other objects. An object may be selected based on the analysis as a starting point for further examination. An object with the lowest cost may be selected for the further examination. The cost may be determined for each analysed object based on the number of relationships each object has with other objects.

The query may comprise a string of name items. The string of name items may be arranged in subsequent tokens, one token of the string indicating a name of one object and another token adjacent to the one token indicating a name of another object, said other object being a direct or indirect child or parent for said one object.

The further examination may comprise comparing relationships associated with the selected object to information in the query.

The objects may be placed in different structures, the structures associating the objects with different relationships categories. The queried object and at least one other object indicated by the query may be associated with different structures. The objects may also have more than one name. The different names are indicated by aspects of the object. An object may also be placed in more than one location in the structures.

The string of name items may comprise at least one symbol between the name items. The at least one symbol may be adapted to describe the relation between the objects the said at least one symbol associates with.

The scope of the search performed in response to the query may be limited by information in the query. The scope of the search accomplished in response to the query may be limited by defining limitations to the search scope. Objects for the analysis of the relationships may be selected based on the information included in the query.

According to another aspect of the present invention there is provided a computer program comprising program code means for performing any of steps of claim 1 or any claim dependent thereto when the program is run on a computer. The program code means may be stored in a computer readable medium. The computer program may be used for finding an object in a computerised control system.

According to another aspect of the present invention there is provided a method in a computerised control system. In accordance with said method objects representing real world entities are associated with different relationship groups based on characteristics of the real world entities. A search for an object by means of a query string containing information regarding the object is then initiated. Searching is accomplished for the object based on a name associated with the object, relationships the object has with other objects and information that associates with relationship groups relevant for the searched object. A path of related objects that corresponds information in the query string and includes the searched object is selected.

According to a still another aspect of the present invention there is provided a data processing system. The system comprises a processor adapted for object oriented data processing, and data storage means adapted for storing data objects. The objects are enabled to have relationships between each other and to be associated with different relationship groups. The data processing system is adapted to provide the processor with an indication of the location of an object in the data storage means based on information regarding a name associated with the object, relationships the object has with others of the objects, and the relationship groups.

The indication may be based on a path of related objects, the object being one object on the path of related objects. The processor may be adapted to generate a query containing information regarding the object and at least one other object having a relationship with the object. The processor may be adapted to control operation of a system consisting of real world entities, the real world entities being represented by objects stored in the storage means.

According to a still further aspect of the present invention there is provided a computer data signal embodied for communication in a computerised system. The communication is associated with location of objects in data storage means of the system. The objects are enabled to have relationships between each another and be associated with different relationship groups. The data signal comprises information associated with a location of an object in the data storage means based on information regarding a name associated with the object, relationships the object has with others of the objects, and the relationship groups.

The information may comprise at least one path of related objects, the object being one of the objects on said at least one path of related objects. The computer data signal may be generated at a search function of the computerised system to respond to a query signal, said query signal containing information regarding the object and at least one other object having a relationship with the object. The computerised system may be adapted to control, based on the computer data signal, operation of a system consisting of real world entities, the real world entities being represented by objects stored in the storage means.

The embodiments of the invention provide a method and arrangement by means of which a search function does not necessarily need to know the actual look-up name of an object, and/or the folders in a path to the object, but the object may be found based on analysing contextual information. The search function may be made faster than what it could be if exact name information is required for the search. Some embodiments enable name look-up in a context where a substantially large number of objects exist in a computerised system. The objects to be located may have a number of structure links i.e. associations between groups of objects associated therewith. The objects may also have multiple names and be located based on only one of the different possible names. It may be possible to reduce the required system overheads that are required for carrying out a search. The embodiments may also provide a more flexible search strategy.

### BRIEF DESCRIPTION OF DRAWINGS

For better understanding of the present invention, reference will now be made by way of example to the accompanying drawings in which:

FIG. 1 illustrates relationships objects may have with other;

FIG. 2 shows objects that have been arranged in two structures;

FIG. 3 illustrates how objects may have relationships with other objects in accordance with one embodiment of the present invention;

FIG. 4 shows a schematic presentation of a plant and grouping of objects in different structures; and

FIG. 5 is a flowchart illustrating an embodiment.

### DESCRIPTION OF PREFERRED EMBODIMENTS OF THE INVENTION

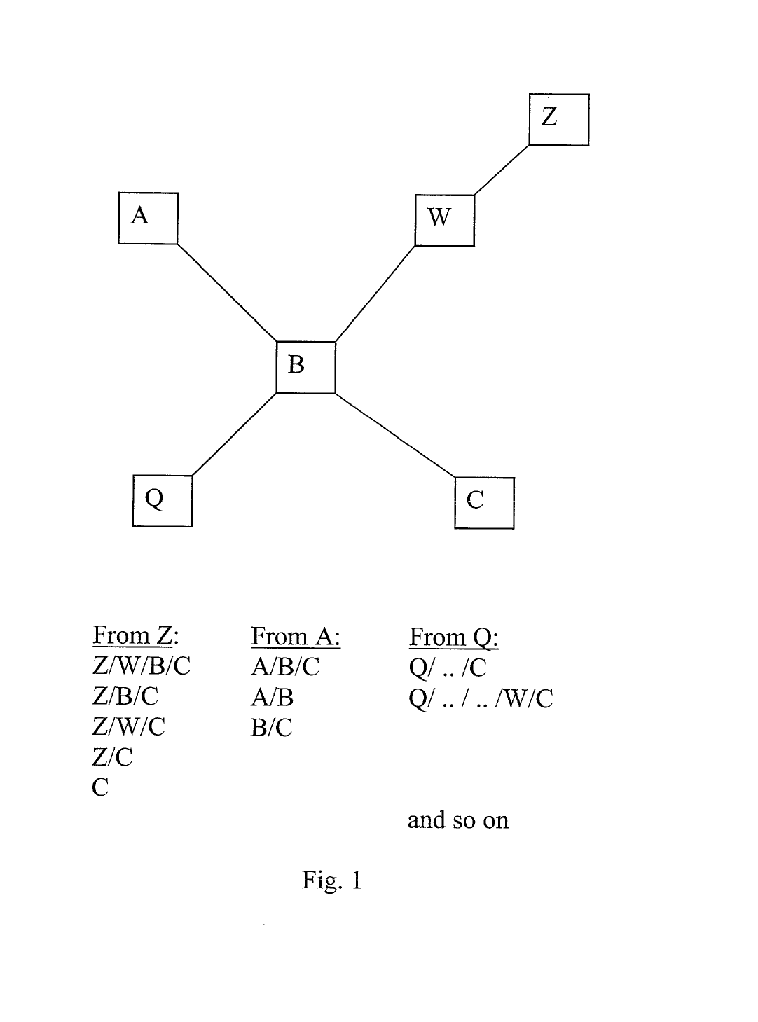

The following will describe in more detail an embodiment wherein a ‘name string’ is used as a query to obtain an object identifier based on contextual information that relates to the relationships between different objects and also to the relationships between different groups of objects. The objects to be searched for may also have more than one name, and the search may be based on any of these names and/or any other search direction or instruction. The location of a requested object the search function returns may comprise a path of related objects, the path leading the caller of the object to the requested object. FIG. 1 shows an example of relationship paths between objects.

More particularly, FIG. 1 shows 6 objects having relationships with each other and several different paths between the related objects. For example, objects ‘Q’, ‘B’, ‘W’ and ‘Z’ form a path. The location of the object ‘Z’ can be indicated by returning the path formed between ‘Q’ and ‘Z’, whereafter the object ‘Z’ may be located and fetched by following the path from ‘Q’ or any other object on the path to object ‘Z’. FIG. 1 includes also a table for possibilities to locate object ‘C’. The possibility of using different symbols in a search string will be discussed in more detail later in this description.

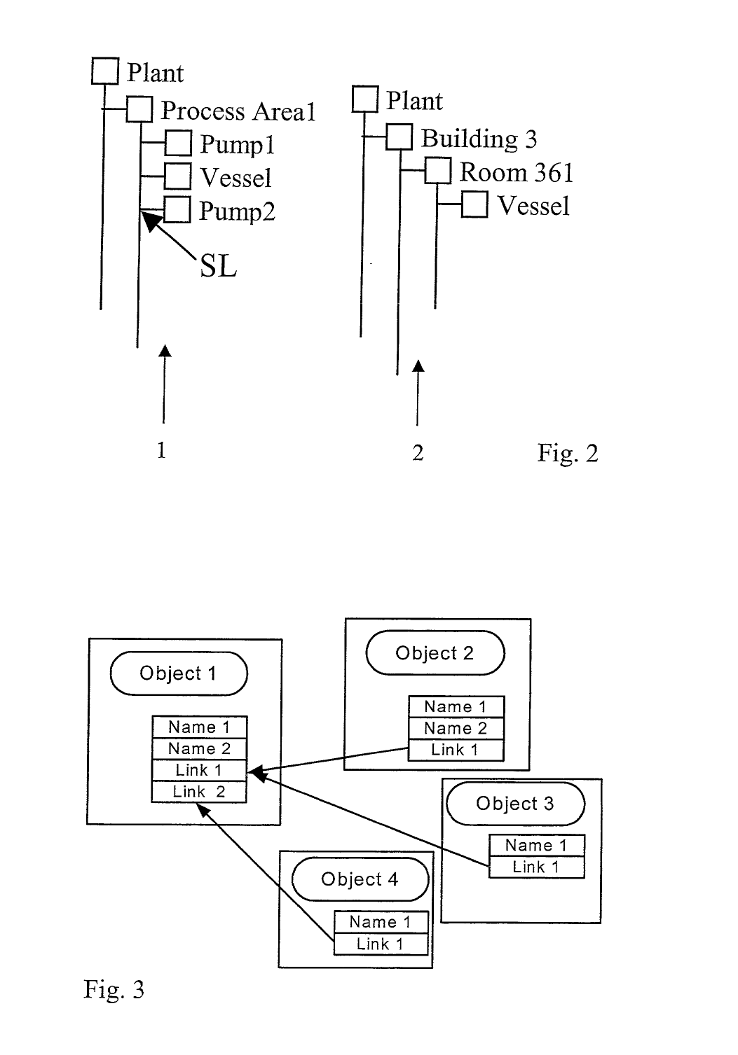

FIG. 2 is a simple example showing objects that are arranged in object groups in two different structures. In here an object group refers to a group of objects comprising an object and all descendants of that object. In this context the structures refer to a way to organise the different groups of objects in a “tree-like” arrangement based on the relationships or associations between the objects in each group and also the relationships between the different groups. Each object is linked to an appropriate structure by means of a structure link of the object. An example of the structure links is a structure link between an object ‘Pump2’ and structure 1 that is indicated by arrow SL.

As shown in FIG. 2, an object may be placed i.e. reside in several different structures. More particularly, an object ‘Vessel’ has been linked to two different structures 1 and 2. The object ‘Vessel’ can be seen as placed in a first structure 1 having a root ‘Process Area1’ and also in a second structure 2 having a main root ‘Building 3’. In the second structure the object ‘Vessel’ is placed below a sub-root ‘Room 361’, i.e. is linked indirectly to the structure ‘Building 3’ via an object ‘Room 361’. Although not shown, it should be appreciated that an object may also reside in multiple positions within one structure.

The structures may be based on different characteristics of the system. A structure may be based on the location of the real world entities that the objects represent, one could be based on control features and one on functional features and so on.

It shall be appreciated that although FIG. 1 shows only one name per object, each of the object may have several different names.

Each link or placement in the structures is represented by a structure link. Each link may be represented in an object as a structure link aspect. The different names that associate with objects may also be represented as aspects. FIG. 3 shows four objects that are linked through aspects ‘Link 1’ and ‘Link 2’. The aspects are placed in association with each of the objects. By means of the aspects the objects can be arranged in a hierarchical structure having one clear root and a clear set of children at each level in the hierarchy. That is, the aspects can be used to enable grouping of the objects and/or placement of the objects e.g. in the “tree-like” structured arrangement of FIG. 2.

As was already mentioned, an object may be located based on information regarding the relationships between different objects and/or between different object groups. Information regarding these relationships can be based on information of the way the objects are linked by means of the structure link aspects.

According to the preferred embodiment a query for an object is based on a name string. A name string can be built up from a sequence of name items. The sequence of name items may contain name aspects and a set of special symbols. The symbols can be used to describe where an object in the string can be found. The special symbols may be any appropriate symbols or combinations thereof, for example ‘. . .’, ‘. .’, ‘.’ or ‘/’, ‘//’, and so on.

To give an example of the use of the symbols, if the above “dot” symbols are used, the triple dotted periods in the name string can be dedicated to indicate any parent, the double dotted periods can be dedicated to indicate the current parent and the simple dot the current structure link. These symbols can be interpreted so that a name string identifies an object and then uses the next token in the string to specialise a name of a child object in any structure unless a special symbol sets restrictions regarding the possible structures.

The following example clarifies the use of the relationships between the objects and symbols between the object names. A name string ‘A B C . . . D E’ instructs the search function to find any set of objects that matches the given criteria. More particularly, the above string gives the following instructions: Find an object A that has a child B (possibly not direct) where B has a child C. Furthermore, the name C should have a parent (at any level) named D, which in turn should have a child E. It should be appreciated that in this example any structure transition may occur in any child or parent relation.

The term ‘direct child’ refers to a child that is a direct descendant of an object. The term any child refers to a child that may be a direct child or an indirect child (e.g. a direct child of any direct child) in the structure defining the relationships between the objects. It should be appreciated that the path of relationship is not restricted to three level of objects (i.e. parent-1^{st} child-2^{nd} child), but may comprise more than three generations of relationships.

The name string may be defined to bind the search e.g. to direct children only. The number of name aspects to be examined may also be reduced. For example, a name can be preceded by a definition in a square bracket that limits the scope of the aspect and/or names. In this case the string of object names could be written as ‘A/[relative name]B/C’, wherein the relative name is the name category that needs to be examined. Another possibility to reduce the syntax or limit the search scope is to define what main categories (but nothing else) should be examined during the name look-up. In this approach the programmer may define those main categories that need to be searched. In the same manner it is possible to limit the set availability of structure transitions by explicitly specifying the structures that are to be examined. This can be implemented e.g. by defining the available structure transitions by appropriate symbols in the string.

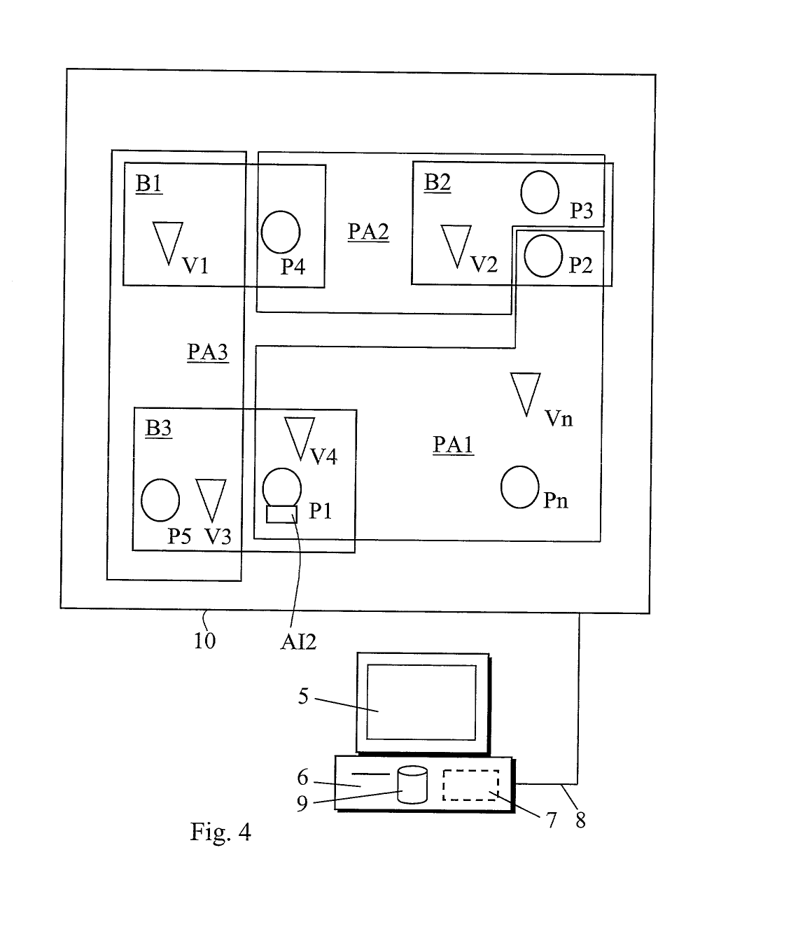

The next example is described with reference to FIGS. 2 and 4. FIG. 4 shows a plant 10. The plant 10 comprises three buildings B1 to B3. In each building there are one or more pumps P1 to P5 and valves V1 to V4. FIG. 4 shows further three different process areas PA1 to PA3. The process areas do not depend on the buildings, but depend rather on the functions of the process in an appropriate manner. Therefore e.g. process area PA1 includes pump P1 and valve V4 from building B3 and pump P2 from building B2. The process area PA1 is also shown to include a valve Vn and a pump Pn that are not associated (at least directly) to any building.

The operation of the various components of the plant 10 is controlled by computer system 6. The computer system 6 may comprise any appropriate data processing facility, such as central processor unit (CPU) 7 of a PC and a database 9, such as a hard disk of a PC. The computer 6 may be provided with auxiliary devices such as a display 5, keyboard, a mouse and so on. The computer is enabled to communicate with the various elements of the plant 10 via a data connection 8, such as a local area network (LAN), other data network or a field bus. The skilled person is aware of various possibilities for the basic components of the computerised control system, and these will thus not be explained in more detail herein.

A search string ‘Building3/Pump/AI2’ is given to the search function of the computerised control system, wherein ‘AI2’ is the name for an object representing the analogue input for the pump. The object ‘Building 3’ (B3 in FIG. 4) is located in the second structure 2. Thus the search function shall examine the location structure 2 to find the object ‘Building 3’. However, as shown by FIG. 4, the object name ‘Building3’ i.e. building B3 may contain a number of pumps, i.e. pumps P1 and P5. Therefore the search function may only receive indication that at least a pump is located in the object name ‘Building3’. However, the pump can be any pump and thus the search function cannot define which one of the pumps is the correct one. Thus the input object name ‘AI2’ cannot be found solely based on the location structure or it may not be a unique name unless specified further through a context.

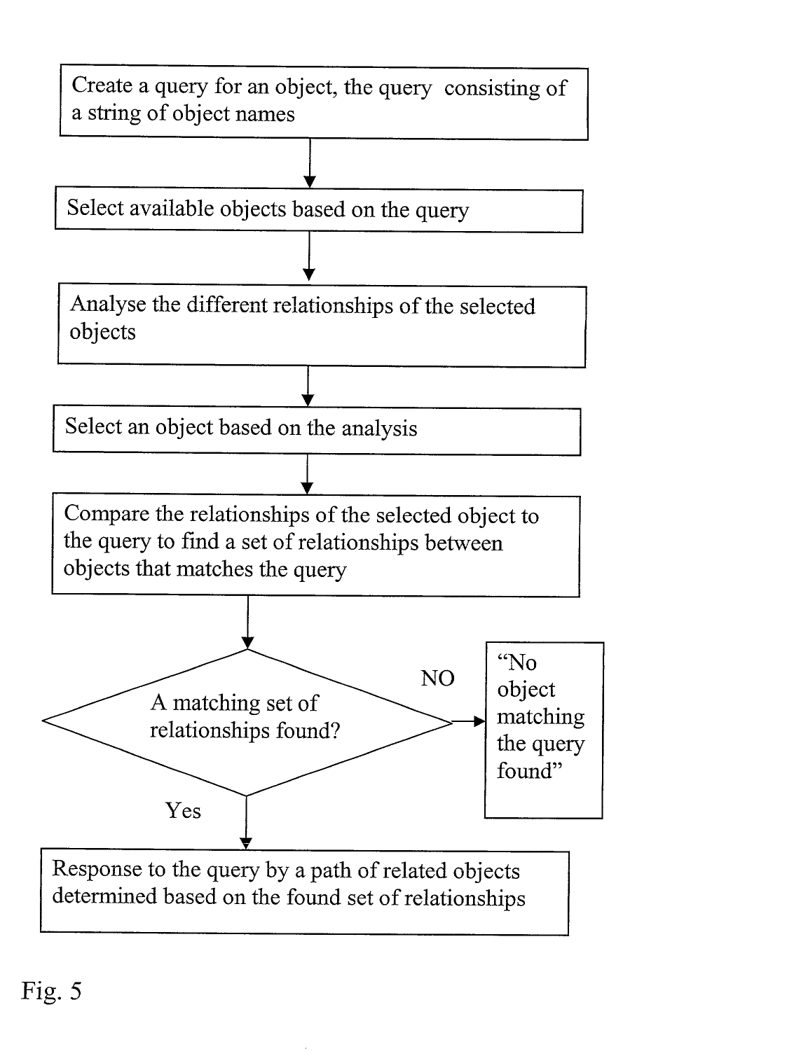

To find the pump that has an analogue input named AI2 the control system shall also use information associated with the location structure or any other structure, for example the control structure or function structure to find an analogue input with the name ‘AI2’. During the look-up possible names for the objects and the relationships between the objects and the object groups are analysed. An exemplifying procedure for this will be discussed in more detail below with reference to FIG. 5. In the FIG. 4 example the search function should analyse information regarding the relationships with the objects of the process areas PA1 and PA3 as well as objects that associate with building B3 and/or pumps in building B3. The end result should be that the name AI2 associates with the pump P1 in building B3.

The search function may be provided by the CPU 7 or other processor of the computer 6 of FIG. 4. The search function may respond a query signal by a computer data signal. The response signal may be generated at the search function such that it comprises information associated with the location of the requested object in the data storage means 9. The information is based on information regarding the name that associates with the requested object, relationships the object has with others of the objects, and the relationship groups. More particularly, the information returned by the search function may comprise at least one path of related objects such that the requested object is one of the objects on said at least one path of related objects.

The processor 7 of the computer may be adapted to provide the control function and to generate the query signal that is transported to the search function. The search function may also be provided by the processor 7. The search and control functions may also be provided by different processors or even by different computer entities that are provided with a communication connection enabling data signalling between the functions.

An algorithm that may be used to compute the set of related objects that in a predefined manner matches a given query string is as follows (see also FIG. 5):

1. Preparation: Compute or select otherwise a set of available objects (and/or names of the objects) in the system. The available objects may obtained e.g. from an object directory service or alike.

2. Preparation: Compute the number of relationships possible through each of the available in the system and assign the computed number of relationships as a cost to each of the selected objects.

3. Break the query string into tokens.

4. Select an object having the smallest costs (i.e. the lowest number of relationships through it).

5. Examine the relationships of the selected object to select a path that matches the given query or paths that match the query.

6. Return the selected one or more paths of related objects (or object names).

The available objects that are computed or otherwise selected for the analysis may be all possible objects in the system. According to an alternative embodiment the number of available objects is limited based on an appropriate criteria, e.g. by selecting only a limited amount of the available objects. The limitation of the objects to be analysed may be based on the information in the query. It is also possible to restrict the possible transitions between the structure groups. The search may also be limited e.g. to certain object categories defined in the name string.

The number of relationships each of the analysed objects has with other objects is determined in the analysis. Based on the analysis an object is selected to be used as a starting point for further examination. If such a path of related object can be found based on the selected object that matches the query, the found path of related objects is returned as response to the query. If a matching path of related objects cannot be found based on the selected object, a message may be returned indication that the object was not found. Another object may be selected whereafter the verifying process is repeated for this object. The further examination process loop may be run until a path of related objects is found that matches the search criteria.

The object that is selected for the further examination may be an object with the lowest cost. The cost is determined for each analysed object and is based on the number of relationships each object has with other objects. The greater the number the greater the cost.

The cost function can be exemplified by the following simple example: If the relationships links between the selected objects A, B and C are A/B and B/C, this would mean that A has one relationship with other objects (with B), B has two relationships (with A and C) and C has one relationship (with B). In other words, A and C both have the lowest cost and B has the highest cost. Since both A and C have only one relationship with other objects, either of them could be chosen as the starting point. The selection between A and C may be based on any appropriate criteria. For example, a first object (i.e. A) in alphabetical order may be selected.

The name lookup may provide benefits especially in arrangements where a number of objects exist in a scope of objects and where each object may have a number of different names and structure links associated with it.

It should be appreciated that whilst embodiments of the present invention have been described in relation to equipment in a processing plant, embodiments of the present invention are applicable to any field of data processing and to any types of objects. For example, the name look-up may be accomplished in different kind of data networks such as in local area networks (LAN), intranet networks or open data networks such as the Internet. The embodiment may also be employed in systems employing distributed data processing, such as in distributed control programs or in control programs that execute distributed tasks.

It is also noted herein that while the above describes exemplifying embodiments of the invention, there are several variations and modifications which may be made to the disclosed solution without departing from the scope of the present invention as defined in the appended claims.

1. A method in an object oriented computer system, wherein objects are enabled to have relationships with each other, the method comprising:
receiving a query for a path of related objects, the query including information regarding an object and relationships associated with the object;
analysing the different relationships associated with objects in the system to select objects based on said information included in the query; and
based on said analysis, selecting a path of related objects, one of the objects in the path being the object indicated by the query.

2. A method as claimed in claim 1, wherein the path of related objects extends between said one object and a root of a structure, said structure being arranged to organise objects relative to each other.

3. A method as claimed in claim 1, wherein the step of analysing comprises determination of the number of relationships each analysed object has with other objects.

4. A method as claimed in claim 3, comprising selection of an object based on the analysis as a starting point for further examination.

5. A method as claimed in claim 4, wherein an object with the lowest cost is selected for the further examination.

6. A method as claimed in claim 5, wherein the cost is determined for each analysed object based on the number of relationships each object has with other objects.

7. A method as claimed in claim 1, wherein the query comprises a string of name items.

8. A method as claimed in claim 7, wherein the string of name items is arranged in subsequent tokens, one token of the string indicating a name of one object and another token adjacent to the one token indicating a name of another object, said other object being a direct or indirect child or parent for said one object.

9. A method as claimed in claim 4, wherein the further examination comprises comparing relationships associated with the selected object to information in the query.

10. A method as claimed in claim 7, wherein the string of name items is broken into tokens before the step of analysing.

11. A method as claimed in claim 1, wherein the objects are placed in different structures, the structures associating the objects with different relationships categories.

12. A method as claimed in claim 11, wherein the queried object and at least one other object indicated by the query are associated with different structures.

13. A method as claimed in claim 1, wherein the objects are enabled to have more than one name.

14. A method as claimed in claim 13, wherein the different names for an object are indicated by aspects of the object.

15. A method as claimed in claim 11, wherein an object is placed in more than one location in the structures.

16. A method as claimed in claim 11, wherein the query contains information regarding at least one structure with which the object is expected to associate with.

17. A method as claimed in claim 4, comprising the step of selecting a second object in the event that it is determined impossible to select the queried path of related objects based on said one selected object.

18. A method as claimed in claim 17 when appended to any of claims 3 to 12, wherein the step of selecting the second object comprises selection of an object with a different number of relationships than what said one object has.

19. A method as claimed in claim 7, wherein the string of name items comprises at least one symbol between the name items.

20. A method as claimed in claim 19, wherein the at least one symbol describes the relation between the objects the said at least one symbol associates with.

21. A method as claimed in claim 1, wherein the scope of the search performed in response to the query is limited by information in the query.

22. A method as claimed in claim 1, wherein the scope of the search accomplished in response to the query is limited by defining limitations to the search scope.

23. A method as claimed in claim 1, comprising a step of selecting objects for the analysis of the relationships based on the information included in the query.

24. A computer program comprising program code means for performing any of steps of claim 1 when the program is run on a computer.

25. A computer program as claimed in claim 24, the program code means being stored in a computer readable medium.

26. Use of a computer program as claimed in claim 24 for finding an object in a computerised control system.

27. A method in a computerised control system, comprising:
associating objects representing real world entities to different relationship groups based on characteristics of the real world entities;
initiating a search for an object by means of a query string containing information regarding the object;
searching for the object based on a name associated with the object, relationships the object has with other objects and information that associates with relationship groups relevant for the searched object; and
selecting a path of related objects that corresponds information in the query string and includes the searched object.

28. A data processing system comprising:
a processor adapted for object oriented data processing;
data storage means adapted for storing data objects, the objects being enabled to have relationships between each other and to be associated with different relationship groups;
wherein the data processing system is adapted to provide the processor with an indication of the location of an object in the data storage means based on information regarding a name associated with the object, relationships the object has with others of the objects, and the relationship groups.

29. A data processing system as claimed in 28, wherein the indication is based on a path of related objects, the object being one object on the path of related objects.

30. A data processing system as claimed in 28, wherein the processor is adapted to generate a query containing information regarding the object and at least one other object having a relationship with the object.

31. A data processing system as claimed in claim 28, wherein the processor is adapted to control operation of a system consisting of real world entities, the real world entities being represented by objects stored in the storage means.

32. A computer data signal embodied for communication in a computerised system, the communication being associated with location of objects in data storage means of the system, and the objects being enabled to have relationships between each another and be associated with different relationship groups, wherein the data signal comprises information associated with a location of an object in the data storage means based on information regarding a name associated with the object, relationships the object has with others of the objects, and the relationship groups.

33. A computer data signal as claimed in claim 32, wherein the information comprises at least one path of related objects, the object being one of the objects on said at least one path of related objects.

34. A computer data signal as claimed in claim 32, wherein the computer data signal is generated at a search function of the computerised system to respond to a query signal, said query signal containing information regarding the object and at least one other object having a relationship with the object.

35. A computer data signal as claimed in claim 32, wherein the computerised system is adapted to control, based on the computer data signal, operation of a system consisting of real world entities, the real world entities being represented by objects stored in the storage means.

36. A method in an object oriented computer system wherein objects are enabled to have relationships with each other, the method comprising:
receiving a query for a path of related objects, the query including information regarding an object and relationships associated with the object;
analysing the different relationships associated with objects in the system to determine the number of relationships each of the objects has with other objects; and
based on said analysis, selecting a path of related objects, one of the objects in the path being the object indicated by the query.
